(19) United States
(12) Patent Application Publication
(10) Pub. No.: US 2026/0020550 A1
(43) Pub. Date: Jan. 22, 2026

(54) LINE REVERSING DEVICE

(71) Applicant: James F. Brewer, JR., Southampton, PA (US)

(72) Inventor: James F. Brewer, JR., Southampton, PA (US)

(21) Appl. No.: 18/779,494

(22) Filed: Jul. 22, 2024

(51) Int. Cl. A01K 89/00

(52) U.S. Cl. CPC A01K 89/003

(57) ABSTRACT

A line reversing device includes a first intermediary spooling assembly with a first intermediary spool and a second intermediary spool assembly with a second intermediary spool. The first intermediary spool can receive a line from an original spool having a spool of wound line. By winding the line from the original reel spool around the first intermediary spool, the line is reversed. The second intermediary spool can receive the line from the first intermediary spool. By winding the line from the first intermediary spool around the second intermediary spool, the line is un-reversed. The line can be wound off of the second intermediary spool and on to either the original reel spool or a new reel spool, thereby reversing the line.

### TECHNICAL FIELD

The present invention relates generally to a line reversing device for reverse line wound on a spool.

### BACKGROUND

When fishing, only the fishing line on the outside of the line wound about the spool is repeatedly cast out and brought back in. This repeated action along with the associated exposure to water, ultraviolet rays from the sun, and other environmental conditions degrades this outside portion of the line, causing it to degrade, for example by becoming discolored, brittle, and to lose its strength. At a certain point, the outside portion of the line may become so degraded that it should no longer be used, as it could break during use when the person fishing has a fish on the line. At such a point, a user can take the line off its spool, throw it away, purchase a new line, and wind that new line onto the spool. This option can be expensive, because it requires the user to purchase a new line, and wasteful, because part of the line the user throws away is still effectively new.

A desirable solution would provide a device to reverse the line on a spool. Even more desirable would be to provide a single device, operable by a single person to reverse the line on a spool.

The present disclosure is directed to overcoming these and other problems of the prior art.

### SUMMARY

Embodiments of the present invention address and overcome one or more of the above shortcomings and drawbacks, by providing devices, kits, and methods related to a line reversing device.

In an exemplary embodiment, a line reversing device includes a first intermediary spooling assembly with a first intermediary spool and a second intermediary spool assembly with a second intermediary spool. The first intermediary spool can receive a line from an original spool having a spool of wound line, wherein the line has a first end in contact with the original reel spool and a second end positioned on the outside of the wound line on the original reel spool. By winding the line from the original reel spool around the first intermediary spool, the line is reversed so that the second end of the line is in contact with the first intermediary spool and the first end of the line is positioned outside of the wound line on the first intermediary spool. The second intermediary spool can receive the line from the first intermediary spool. By winding the line from the first intermediary spool around the second intermediary spool, the line is un-reversed the line so that the first end of the line is in contact with the second intermediary spool and the first end of the line is positioned outside of the wound line on the second intermediary spool. The line can be wound off of the second intermediary spool and on to either the original reel spool or a new reel spool, thereby reversing the line so that the second end of the line is in contact with the original reel spool or the new reel spool, as applicable, and the first end of the line is positioned outside of the wound line on the original reel spool or the new reel spool, as applicable.

In some embodiments, each of the first and second intermediary spooling subassemblies have an axle, with each of the first and second intermediary spools on a respective axle.

In some embodiments, each of the first and second intermediary spooling subassemblies have one or more risers attached to and extending perpendicularly from a top surface of a base, and the axle extends from a top end of the one or more risers.

In some embodiments, the one or more risers comprise two risers and each respective axle extends between a respective two risers.

In some embodiments, each of the first and second intermediary spooling subassemblies have two tensioning shaft collar locks on the axle, each proximate a respective one of the two risers. The locations of the two tensioning shaft collar locks relative to respective one of the two risers can at least partially control the tension of a line as it is wound about the intermediary spool.

In some embodiments, the two tensioning shaft collars locks are permanently connected to their respective locations along the axle such that the tension is pre-set and cannot be adjusted.

In some embodiments, the locations to the two tensioning shaft collar locks are adjustable such that the tension can be adjusted by relocating one or more of the two tensioning shaft collar locks.

In some embodiments, each tensioning shaft collar lock is located between a respective intermediary spool and a respective one of the two risers.

In some embodiments, each of the first and second intermediary spooling subassemblies have two positioning shaft collar locks on the axle, one on either side of the intermediary spool.

In some embodiments, each of the first and second intermediary spooling subassemblies have two positioning shaft collar locks on the axle, one on either side of the intermediary spool, to maintain the intermediary spool at a location on the axle.

In some embodiments, for each of the first and second intermediary spooling subassemblies, the intermediary spool is removably connected to the axle such that it can be replaced with a replacement spool of a different size.

In some embodiments, each of the first and second intermediary spooling subassemblies have a crank attached to an end of the axle to facilitate rotation of the axle

In some embodiments, the first intermediary spooling subassembly has a crank removably connected to an end of the respective axle such that the crank can be removed from the first intermediary spooling subassembly and connected to the second intermediary spooling subassembly.

In some embodiments, an end of each respective axle is configured to mate with a motorized device such that the motorized device can selectively connect to and drive rotation of each respective axle.

In some embodiments, the motorized device is a drill.

In some embodiments, for each of the first and second intermediary spooling subassemblies, a first end of a respective axle can mate with a motorized device to drive rotation of the respective axle and each of the first and second intermediary spooling subassemblies have a crank to be connected to a second end of the axle to facilitate hand-rotation of the axle.

In some embodiments, a flange of each of the first and second intermediary spools has a slit to receive a line.

In some embodiments, the line reversing device has a line counter to measure a line while the line is wound onto the second intermediary spool.

In another exemplary embodiment, a line reversing kit includes a rotation assistance device and a line reversing device. The line reversing device includes a first intermediary spooling assembly with a first intermediary spool and a second intermediary spool assembly with a second intermediary spool. The first intermediary spool can receive a line from an original spool having a spool of wound line, wherein the line has a first end in contact with the original reel spool and a second end positioned on the outside of the wound line on the original reel spool. By winding the line from the original reel spool around the first intermediary spool, the line is reversed so that the second end of the line is in contact with the first intermediary spool and the first end of the line is positioned outside of the wound line on the first intermediary spool. The second intermediary spool can receive the line from the first intermediary spool. By winding the line from the first intermediary spool around the second intermediary spool, the line is un-reversed the line so that the first end of the line is in contact with the second intermediary spool and the first end of the line is positioned outside of the wound line on the second intermediary spool. The line can be wound off of the second intermediary spool and on to either the original reel spool or a new reel spool, thereby reversing the line so that the second end of the line is in contact with the original reel spool or the new reel spool, as applicable, and the first end of the line is positioned outside of the wound line on the original reel spool or the new reel spool, as applicable. The rotation assistance device can be selectively attached to and used to rotate each of the first and second intermediary spooling subassemblies.

In some embodiments, a line reversing kit further includes a replacement spool to replace the first intermediary spool. The replacement spool can be larger than the first intermediary spool such that it can accommodate a greater length of line.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. In the drawings, similar symbols typically identify similar components, unless context dictates otherwise. Included in the drawings are the following Figures:

FIG. 1 is a perspective view of a line reversing device, according to an embodiment of the present disclosure;

FIG. 2 is a front view of a line reversing device, according to an embodiment of the present disclosure; and

FIGS. 3A-3I illustrate a line reversal process using the line reversing device disclosed herein, according to embodiments of the present disclosure.

### DETAILED DESCRIPTION

The present disclosure details devices, kits, and methods related to a line reversing device to reverse the finishing line wound on a fishing reel spool. In some embodiments, the device can be operated by a single person. As discussed above, when fishing, only the fishing line on the outside of the line wound about the spool is repeatedly cast out and brought back in. This repeated action along with the associated exposure to water and ultraviolet rays from the sun degrades this outside portion of the line, causing it to become discolored, brittle, and to lose its strength. At a certain point, the outside portion of the wound line will become so degraded that it should no longer be used, or can no longer be used. At such a point, a user can reverse the line on the spool to make available the inside portion of the wound line, effectively doubling the life of the fishing line. This option is less expensive and less wasteful than disposing of the fishing line and purchasing a new fishing line to replace it.

The line reversing device disclosed herein swaps the positions of the “old” used portion of the line on the inside of the wound line and the “new” unused portion of the line on the outside of the wound line on a user's reel spool. After reversal, the “old” used portion of the line is moved to the inside of the wound line on the user's reel spool while the “new” unused portion of the line is moved to the outside of the wound line on the user's reel spool, available to be cast out. While the Figures show spinning and conventional reels, it is to be understood that the disclosed technology can be used with any type of reel.

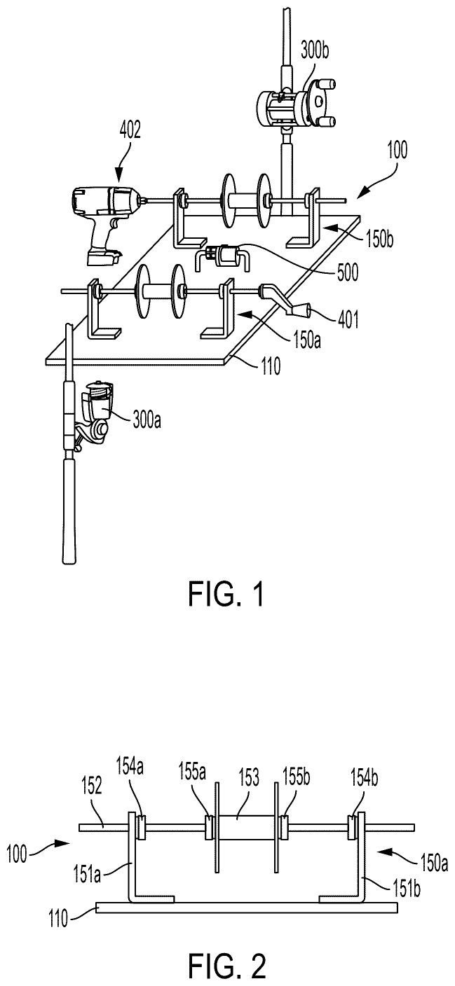

Turning now to the Figures, FIG. 1 is a perspective view of a line reversing device 100, according to an embodiment of the present disclosure. The line reversing device 100 can include a base 110 and two intermediary spooling subassemblies 150a, 150b attached to the base 110. As will be described in further detail below, the line reversing device 100 can be used to reverse the line on a user's reel spool by winding the line off of the user's reel spool 300a and onto the first intermediary spooling subassembly 150a, then winding the line off of the first intermediary spooling subassembly 150a and onto the second intermediary spooling subassembly 150b, and then winding the line off of the second intermediary spooling subassembly 150b and onto the user's original reel spool 300a, or the user's new reel spool 300b. In some embodiments, the line reversing device 100 can also include a line counter 500 to measure the line during this process.

FIG. 2 is a front view of a line reversing device 100, according to an embodiment of the present disclosure. As illustrated in FIG. 2, each intermediary spooling subassembly 150 can include two risers 151a, 151b; an axle 152; a spool 153; two tensioning shaft collar locks 154a, 154b; and two positioning shaft collar locks 155a, 155b.

The risers 151a, 151b can be attached to and extend perpendicularly from the top surface of the base 110. The risers 151a, 151b can hold the axle 152 and the spool 153 thereon. Further, the risers 151a, 151b can be tall enough so that the spool 153 can freely rotate without interference from the base 110. In some embodiments, the risers 151a, 151b are L-brackets screwed into the base 110.

The axle 152 can extend between the two risers 151a, 151b and can be rotated to wind the line around the spool 153 during a line reversal process. In some embodiments, the axle 152 may be a 9 mm aluminum rod, although other sizes and materials are possible.

In some embodiments, at least one end of the axle 152 extends outward past a riser 151 and can be connected to a component to drive rotation of the axle 152. For example, referring back to FIG. 1, a hand crank 401 or a motorized device 402, like a drill, can be attached to the portion of the axle 152 that extends past the riser 151. A user can use the hand crank 401 or the motorized device 402 to drive rotation of the axle 152 to wind the line 200 around the spool 153 during a line reversal process. In some embodiments, at least one, if not both, of the intermediary spooling subassemblies 150 have a mechanism that, while the line is being wound about its spool, operates to distribute the line 200 evenly on the spool 153. For example, a spinning-type reel, see 300a in FIG. 1, may transverse up and down as the line is reeled in to evenly distribute the line on the spool, and a conventional-type reel, see 300b in FIG. 1, may have a line distributing mechanism that travels back and forth along the longitudinal length of the spool to evenly distribute the line on the spool as the line is reeled in.

In some embodiments, a removable hand crank is used to attach to and rotate the axles 152 of each intermediary spooling subassembly 150. In other words, a removable hand crank is attached to the axle 152 of the first intermediary spooling subassembly 150a and used to rotate it, and then removed and attached to the axle 152 of the second intermediary spooling subassembly 150b and used to rotate it. In other embodiments, each axle 152 has a hand crank 401 permanently attached to it.

In some embodiments, the axle 152 of each intermediary spooling subassembly 150 extends past both of its risers 151a, 151b, with a hand crank 401 (permanently or removably) attached on one end and the other end available to be connected to a motorized device 402. In this way, each axle 152 can be rotated either by the hand crank 401 on one end or by a motorized device 402 on the other end.

The spool 153 is the component about which the line is wound during the line reversal process. The spool 153 can be installed on and rotate with the axle 152. In some embodiments, the axle 152 extends through an inner diameter of the spool 153. The size of the spool 153 can vary, but it should be large enough to accommodate the full length of line.

In some embodiments, at least one, if not both, of the intermediary spooling subassemblies 150a, 150b has two tensioning shaft collar locks 154a, 154b to control the tension in the line while the line is wound on to or off of the spool 153, simulating a weight at the end of the line. One tensioning shaft collar lock 154a can be installed on the axle 152 abutting one riser 151a, either on the inside of the riser 151a (i.e., between the riser 151a and the spool 153) or on the outside of the riser 151a (i.e., on the side of the riser 151a opposite the spool 153). Similarly, the other tensioning shaft collar lock 154b can be installed on the axle 152 abutting the other riser 151b, either on the inside or the outside of the riser 151b. The proximity of the tensioning shaft collar locks 154a, 154b to respective risers 151a, 151b can affect the tension on the line as it is wound on to or off of the spool 153. If the tensioning shaft collar locks 154a, 154b are very close to the risers 151a, 151b, abutting them very closely, the tension in the line will be greater than if the tensioning shaft collar locks 154a, 154b are not as closely abutted to the risers 151a, 151b.

In some embodiments, the tensioning shaft collar locks 154a, 154b are permanently installed on the axle 152 and cannot be moved such that the tension is preset and cannot be adjusted. In other embodiments, the tensioning shaft collar locks 154a, 154b can be moved along the axle 152 to adjust the tension in the line.

While the use of tensioning shaft collar locks 154a, 154b to control line tension has just been described, the technology disclosed herein is not so limited. Any method known in the art to control the speed of the rotation of the axle 152 can be used. These alternate methods can provide for permanent (“pre-set”) or adjustable tension. Even more, in some embodiments, the axle 152 may be free spinning with the intermediary spooling subassembly 150 having no features to control the speed of the axle 152 rotation.

In some embodiments, at least one, if not both, of the intermediary spooling subassemblies 150 has two positioning shaft collar locks 155a, 155b, one on either side of the spool 153. The positioning shaft collar locks 155a, 155b fix the spool 153 at a position on the axle 152 so that the spool 153 rotates with the axle 152 and is prevented from moving along the axle 152 toward a riser 151 during a line reversal process. As with the tensioning shaft collar locks 154a, 154b, the positioning shaft collar locks 155a, 155b may be fixed or adjustable. If the positioning shaft collar locks 155a, 155b are fixed, a user cannot move them to move the spool 153; the position of the spool 153 along the axle 152 is preset and not adjustable. If the positioning shaft collar locks 155a, 155b are adjustable, a user can move them to move the spool 153 to a different position along the axle 152.

Also as with the tensioning shaft collar locks 154a, 154b, although the use of positioning shaft collar locks 155a, 155b to fix the spool 153 in a particular location along the axle 152 has just been described, the technology disclosed herein is not so limited. Any method known in the art to fix the spool 153 at a location along the axle 152, whether fixed or adjustable, can be used. For example, in some embodiments, the spool 153 can be permanently fixed to the axle 152 with an adhesive. For another example, in some embodiments, there may be no additional features to fix the spool 153 in place; instead, the inner diameter of the spool 153 may be the same size as the diameter of the axle 152 such that the spool 153 fits snugly on the axle 152 and rotates with the axle 152.

It is also noted that, as FIG. 2 illustrates, in some embodiments, the axles 152, and thus the spools 153, are parallel to the base 110. However, in other embodiments, the axles 152, and thus the spools 153, are perpendicular to the base 110. Further, in yet other embodiments, one axle is parallel to and the other axle is perpendicular to the base 110. It is further noted that in some embodiments, only one riser 151 per spooling subassembly 150 is used. In such embodiments, the axle 152 (parallel to the base 110) is a cantilever, free at one end and supported proximate an opposite end by the riser 151.

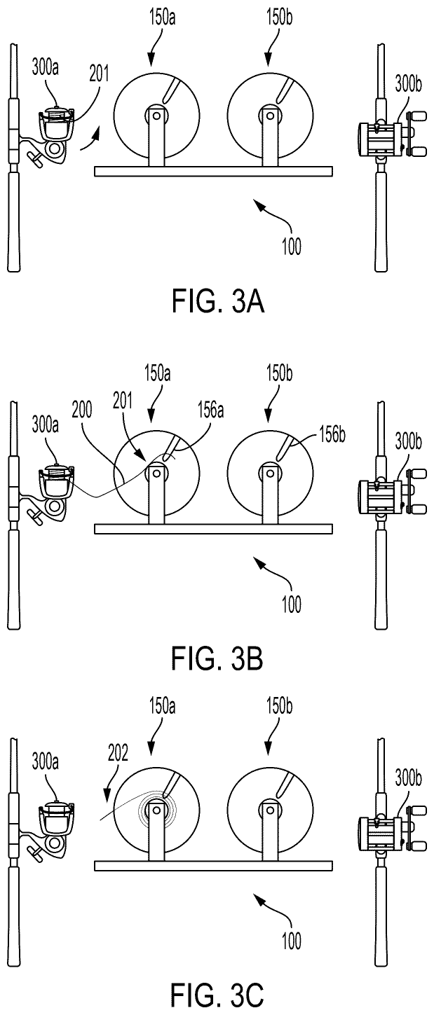

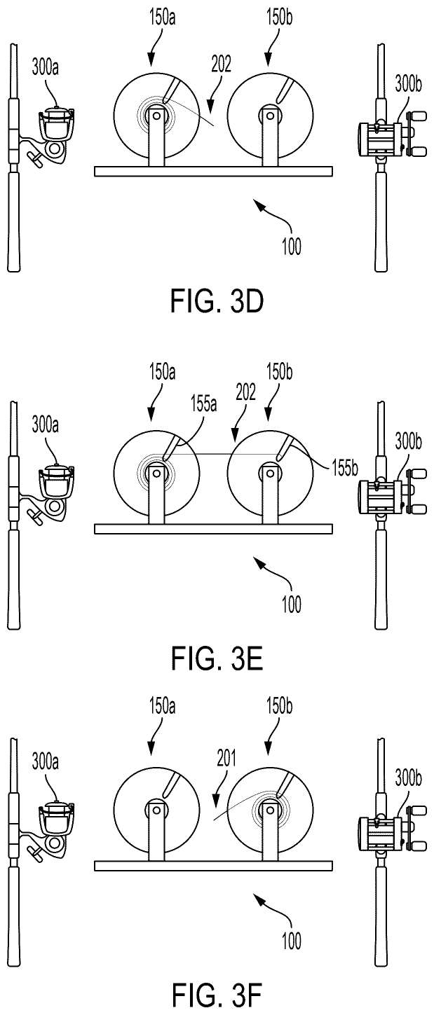

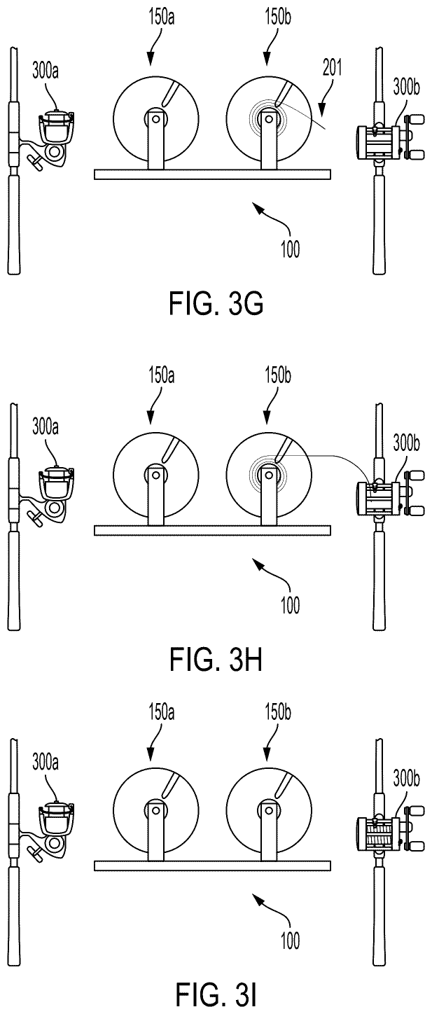

The line reversing device described above can be used to reverse the line wound about a user's fishing spool reel. FIGS. 3A-3I illustrate an embodiment of that process. In the description that follows, reference to “first spool” refers to the spool 153 of the first intermediary spooling subassembly 150a and reference to “second spool” refers to the spool 153 of the second spooling assembly 150b.

Referring now to FIG. 3A, the line 200 is wound on an existing spool and the first and second spools are empty. At FIG. 3B, the “old” used end 201 of the line 200 is securely, but removably, affixed to the first spool by any method known in the art, including, e.g., tying the line 200 around the spool or taping the “old” used end 201 to the spool. In some embodiments, one, if not both, of the spool's flanges has a slit 156a, 156b that can receive the end of a line 200 to removably affix the line 200 to the spool, as shown in FIG. 3B.

With the line 200 affixed to the first spool, the axle 152 can be rotated to wind the line 200 off of the existing spool completely and onto the first spool, as shown in FIGS. 3C and 3D. Once all of the line 200 is removed from the existing spool, its “new” unused end 202 is free and can be removably affixed to the second spool, as shown in FIG. 3E. The “new” unused end 202 can be affixed to the second spool via the same or a different method that was used to affix the “old” used end 201 to the first spool. With the line 200 affixed to the second spool, its axle 152 can be rotated to wind the line 200 off of the first spool completely and onto the second spool, as shown in FIGS. 3F and 3G. In embodiments with a line counter 500, the line counter 500 may be positioned between the first 150a and second 150b intermediary spooling subassemblies and the line 200 may travel through the line counter 500 as it is wound off of the first spool and onto the second spool.

Once all of the line 200 is removed from the second spool, its “old” used end 201 is free and can be permanently affixed, e.g., by tying it, to the user's spool 300, as shown in FIG. 3H. The line 200 can then be wound off of the second spool completely and onto the user's spool 300 by any method known in the art, including using a fishing pole handle with a hand crank. Once the line 200 is wound off of the second spool completely and onto the user's spool 300, the line 200 is reversed, and the “new” unused end is on the outside of the wound line and ready for use. When the line 200 is a fishing line, the “new” unused end can be used to attach to a fishing hook.

While various illustrative embodiments incorporating the principles of the present teachings have been disclosed, the present teachings are not limited to the disclosed embodiments. Instead, this application is intended to cover any variations, uses, or adaptations of the present teachings and use its general principles, and various of the above-disclosed and other features and functions, or alternatives thereof, may be combined into many other different systems or applications. Further, this application is intended to cover such departures from the present disclosure that are within known or customary practice in the art to which these teachings pertain and various presently unforeseen or unanticipated alternatives, modifications, variations or improvements therein may be subsequently made by those skilled in the art.

Additionally, the disclosed technology can be implemented in a variety of examples and can be practiced or carried out in various ways. In particular, the presently disclosed subject matter is described in the context of reversing fishing line on a spool. The present disclosure, however, is not so limited, and can be applicable to other applications. The present disclosure, for example and not limitation, can include reversing any type of cord on any type of spool. Such implementations and applications are contemplated within the scope of the present disclosure. Accordingly, when the present disclosure is described in the context of reversing the fishing line wound around a fishing spool, it will be understood that other implementations can take the place of those referred to.

A second action can be said to be “in response to” a first action independent of whether the second action results directly or indirectly from the first action. The second action can occur at a substantially later time than the first action and still be in response to the first action. Similarly, the second action can be said to be in response to the first action even if intervening actions take place between the first action and the second action, and even if one or more of the intervening actions directly cause the second action to be performed. For example, a second action can be in response to a first action if the first action sets a flag and a third action later initiates the second action whenever the flag is set.

It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

I claim:

1. A line reversing device comprising:
a first intermediary spooling subassembly comprising a first intermediary spool configured to receive a line from an original reel spool having a spool of wound line, the line comprising a first end in contact with the original reel spool and a second end positioned on the outside of the wound line on the original reel spool, by winding the line from the original reel spool around the first intermediary spool, thereby reversing the line so that the second end of the line is in contact with the first intermediary spool and the first end of the line is positioned outside of the wound line on the first intermediary spool; and
a second intermediary spooling subassembly comprising a second intermediary spool configured to receive the line by winding the line from the first intermediary spool around the second intermediary spool, thereby un-reversing the line so that the first end of the line is in contact with the second intermediary spool and the first end of the line is positioned outside of the wound line on the second intermediary spool,
wherein the line is configured to be wound off of the second intermediary spool and on to one of the original reel spool and a new reel spool, thereby reversing the line so that the second end of the line is in contact with the one of the original reel spool and the new reel spool and the first end of the line is positioned outside of the wound line on the one of the original reel spool and the new reel spool.

2. The line reversing device of claim 1, wherein each of the first and second intermediary spooling subassemblies further comprise an axle, wherein the first and second intermediary spools are each on a respective axle.

3. The line reversing device of claim 2, wherein each of the first and second intermediary spooling subassemblies further comprise one or more risers attached to and extending perpendicularly from a top surface of a base, wherein the axle extends from a top end of the one or more risers.

4. The line reversing device of claim 3, wherein the one or more risers comprise two risers and each respective axle extends between a respective two risers.

5. The line reversing device of claim 4, wherein each of the first and second intermediary spooling subassemblies further comprise two tensioning shaft collar locks on the axle, each proximate a respective one of the two risers, wherein the locations of the two tensioning shaft collar locks relative to respective one of the two risers at least partially control the tension of a line as it is wound about the intermediary spool.

6. The line reversing device of claim 5, wherein the two tensioning shaft collars locks are permanently connected to their respective locations along the axle such that the tension is pre-set and cannot be adjusted.

7. The line reversing device of claim 5, wherein the locations to the two tensioning shaft collar locks are adjustable such that the tension can be adjusted by relocating one or more of the two tensioning shaft collar locks.

8. The line reversing device of claim 5, wherein each tensioning shaft collar lock is located between a respective intermediary spool and a respective one of the two risers.

9. The line reversing device of claim 5, wherein each of the first and second intermediary spooling subassemblies further comprises two positioning shaft collar locks on the axle, one on either side of the intermediary spool.

10. The line reversing device of claim 2, wherein each of the first and second intermediary spooling subassemblies further comprise two positioning shaft collar locks on the axle, one on either side of the intermediary spool, to maintain the intermediary spool at a location on the axle.

11. The line reversing device of claim 2, wherein, for each of the first and second intermediary spooling subassemblies, the intermediary spool is removably connected to the axle such that it can be replaced with a replacement spool of a different size.

12. The line reversing device of claim 2, wherein each of the first and second intermediary spooling subassemblies further comprise a crank attached to an end of the axle to facilitate rotation of the axle.

13. The line reversing device of claim 2, wherein the first intermediary spooling subassembly further comprises a crank removably connected to an end of the respective axle such that the crank can be removed from the first intermediary spooling subassembly and connected to the second intermediary spooling subassembly.

14. The line reversing device of claim 2, wherein an end of each respective axle is configured to mate with a motorized device such that the motorized device can selectively connect to and drive rotation of each respective axle.

15. The line reversing device of claim 14, wherein the motorized device is a drill.

16. The line reversing device of claim 2, wherein, for each of the first and second intermediary spooling subassemblies, a first end of a respective axle is configured to mate with a motorized device to drive rotation of the respective axle and each of the first and second intermediary spooling subassemblies further comprises a crank to be connected to a second end of the axle to facilitate hand-rotation of the axle.

17. The line reversing device of claim 1, wherein a flange of each of the first and second intermediary spools forms therethrough a slit to receive a line.

18. The line reversing device of claim 1, further comprising a line counter to measure a line while the line is wound onto the second intermediary spool.

19. A line reversing kit comprising:
a rotation assistance device; and
a line reversing device comprising:
a first intermediary spooling subassembly comprising a first intermediary spool configured to receive a line from an original reel spool having a spool of wound line, the line comprising a first end in contact with the original reel spool and a second end positioned on the outside of the wound line on the original reel spool, by winding the line from the original reel spool around the first intermediary spool, thereby reversing the line so that the second end of the line is in contact with the first intermediary spool and the first end of the line is positioned outside of the wound line on the first intermediary spool, and
a second intermediary spooling subassembly comprising a second intermediary spool configured to receive the line by winding the line from the first intermediary spool around the second intermediary spool, thereby un-reversing the line so that the first end of the line is in contact with the second intermediary spool and the first end of the line is positioned outside of the wound line on the second intermediary spool,
wherein the line is configured to be wound off of the second intermediary spool and on to one of the original reel spool and a new reel spool, thereby reversing the line so that the second end of the line is in contact with the one of the original reel spool and the new reel spool and the first end of the line is positioned outside of the wound line on the one of the original reel spool and the new reel spool,
wherein the rotation assistance device can be selectively attached to and used to rotate each of the first and second intermediary spooling subassemblies.

20. The line reversing kit of claim 19, further comprising a replacement spool configured to replace the first intermediary spool, wherein the replacement spool is larger than the first intermediary spool such that it can accommodate a greater length of line.
